(19) United States
(12) Patent Application Publication
(10) Pub. No.: US 2024/0386508 A1
(43) Pub. Date: Nov. 21, 2024

(54) METHODS FOR MATCHING USERS TO ATTEND EVENTS TOGETHER

(71) Applicant: Kadwi, LLC, Dover, DE (US)

(72) Inventor: Elodie Marlet, Seattle, WA (US)

(73) Assignee: Kadwi, LLC, Dover, DE (US)

(21) Appl. No.: 18/662,805

(22) Filed: May 13, 2024

Related U.S. Application Data
(60) Provisional application No. 63/466,764, filed on May 16, 2023.

(51) Int. Cl. G06Q 50/00; G06Q 10/02

(52) U.S. Cl. CPC G06Q 50/01; G06Q 10/02

(57) ABSTRACT

Computer-implemented methods for matching users to attend events together. The methods include receiving a plurality of user profiles, receiving an event profile comprising details of an event, and receiving a request to create an event group. The method further includes receiving event group parameters, which include gender and age requirements for participation in the event group. Additional steps include creating an event group, identifying qualified users from the plurality of user profiles received, and creating and publishing an event group notice. The method includes receiving event group membership requests and selecting group members for the event group from the qualified users who submitted group membership requests.

### CROSS REFERENCE TO RELATED APPLICATIONS

This application claims priority to copending U.S. Application, Ser. No. 63/466,764, filed on May 16, 2023, which is hereby incorporated by reference for all purposes.

### BACKGROUND

The present disclosure relates generally to social networking methods. In particular, computer-implemented methods for matching users to attend events together are described.

People looking to expand their social circles usually utilize organic methods of meeting new people or utilize social networking platforms. Organic methods of meeting people include introductions through mutual friends or by starting conversations with new people encountered in everyday life, such as at a gym, at a park, or at a store. Examples of social networking platforms include Tinder, Bumble, and Hinge, which are generally focused on forming romantic relationships.

Meeting people organically is often seen as a more genuine way of interacting than through social networking platforms. However, organic methods of meeting people have high transaction costs because engaging with someone with no prior interaction or prior background information can be awkward and intimidating. Meeting people organically also has the disadvantages of being unpredictable, time consuming, and subject to disparate interaction interests.

Conventional social network platforms address some of the challenges associated with organic methods of meeting people, but they have their own limitations. For example, conventional social networking platforms are typically specialized in matching users either for romantic or platonic relationships, but do not accommodate both types of new relationship goals. Additionally, some conventional social networking platforms match users one-on-one while others match users in groups of fixed size or based on common interests. However, in the case of group matching, users often cannot invite their friends outside of the platform to engage with their matches nor can they specify how many people they want to meet and of what age and gender.

It would be desirable if computer-implemented methods existed that were effective to matches individuals into event groups to attend in-person or virtual events together. It would be helpful if such methods allowed people to specify parameters for the event groups to yield event groups comprised of compatible people. For example, it would be useful if the age and gender of the people making up the event group could be specified in advance. It would also be useful if one could specify the number of people making up an event group.

It would be further advantageous if a method of forming groups of people to attend events together enabled people to invite friends to potentially join the event group. It would also be desirable if the method had the capacity to enable members of an event group to communicate prior to the event to become familiar with each other and/or to coordinate logistics ahead of time.

Thus, there exists a need for methods for matching users to attend events together that improve upon and advance the design of known social networking platforms. Examples of new and useful methods for matching users to attend events together relevant to the needs existing in the field are discussed below.

### SUMMARY

The present disclosure is directed to computer-implemented methods for matching users to attend events together. The methods include receiving a plurality of user profiles, receiving an event profile comprising details of an event, and receiving a request to create an event group. The method further includes receiving event group parameters, which include gender and age requirements for participation in the event group. Additional steps include creating an event group, identifying qualified users from the plurality of user profiles received, and creating and publishing an event group notice. The method includes receiving event group membership requests and selecting group members for the event group from the qualified users who submitted group membership requests.

### BRIEF DESCRIPTION OF THE DRAWINGS

FIG. 1 is a schematic view of a first example of a computer system implementing a method for matching users to attend events together.

FIG. 2 is a view of a user device included in the system shown in FIG. 1 depicting an event list user interface screen displaying a list of public and private events a user may review and potentially attend as part of an event group.

FIG. 3 is a view of the user device shown in FIG. 2 depicting an event group list user interface screen displaying a list of published event groups a user may seek to join to attend events with other members in the event groups.

FIG. 4 is a schematic view of the user device shown in FIG. 2 depicting a user interface screen displaying a list of event groups in which the user of the device is a group member.

FIG. 5 is a flow diagram of a first embodiment of a computer-implemented method for matching users to attend events together.

FIG. 6 is a flow diagram of steps included in a step for selecting group members in the method shown in FIG. 5.

FIG. 7 is a flow diagram of steps included in a step for selecting additional group members in the method shown in FIG. 5.

FIG. 8 is a flow diagram of additional steps related to inviting a friend to join an event group optionally included in the method shown in FIG. 5.

FIG. 9 is a flow diagram of additional steps related to deleting an event group optionally included in the method shown in FIG. 5.

FIG. 10 is a flow diagram of additional steps related to providing intra-group communication means optionally included in the method shown in FIG. 5.

FIG. 11 is a flow diagram of additional steps related to qualified users selectively joining event groups together optionally included in the method shown in FIG. 5.

FIG. 12 is a flow diagram of a second embodiment of a computer-implemented method for matching users to attend events together.

FIG. 13 is a flow diagram of steps related to registering a user optionally included in the method shown in FIG. 12.

FIG. 14 is a flow diagram of steps related to creating an event optionally included in the method shown in FIG. 12.

FIG. 15 is a flow diagram of steps related to selecting group members for an event group for a public event optionally included in the method shown in FIG. 12.

FIG. 16 is a flow diagram of steps related to selecting group members for an event group for a private event optionally included in the method shown in FIG. 12.

### DETAILED DESCRIPTION

The disclosed methods for matching users to attend events together will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods for matching users to attend events together are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Contextual Details

Ancillary features relevant to the methods described herein will first be described to provide context and to aid discussing the methods.

### User Devices

The methods described herein are typically utilized by user devices communicating with one or more server computers implementing the methods. The user device is a computing device configured to communicate data with the server computer over a data network.

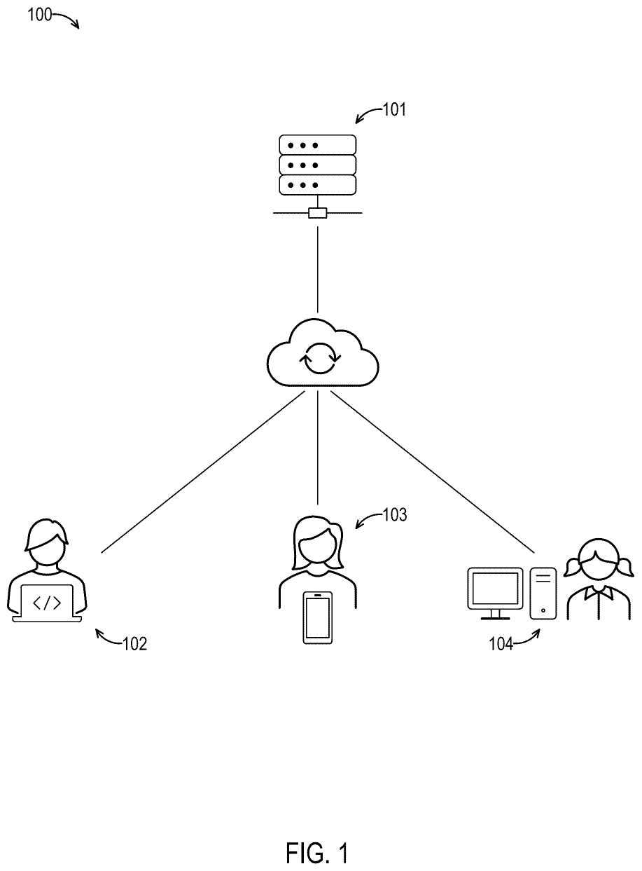

As shown in FIG. 1, a wide variety of user devices may interface with the server computer to implement the methods herein. For example, with reference to FIG. 1, a first user device 102 is a laptop computer used by first user; a second user device 103 is a smart phone used by a second user; and a third user device 104 is a desktop computer used by a third user. Other suitable user devices include tablet computers and wearable devices, such as smart watches or virtual or augmented reality headsets. The user device used to execute the methods described herein may be any currently known or later developed type of computing device.

### Server Computer

The methods described herein are implemented on a computer. Computers configured to exchange data with a plurality of client computers (of which the user devices described herein qualify) over a data network are typically referred to as server computers. Server computers include various components enabling them to execute programmed instructions, store data, and communicate data with client computers.

With reference to FIG. 1, a server computer 101 is configured to implement the methods described herein. The server computer may be any type of computer currently known or later developed suitable for executing programmed instructions corresponding to the method steps described below.

As shown in FIG. 1, server computer 101 exchanges data with user devices over a distributed data network. As such, server computer 101 may be referred to as a cloud computer participating in a cloud computing network.

### Computer-Implemented Methods for Matching Users to Attend Events Together

With reference to the figures, computer-implemented method for matching users to attend events together will now be described. The methods discussed herein function to foster new relationships. In particular, the methods described in this document match users into event groups to facilitate them attending events together.

The reader will appreciate from the figures and description below that the presently disclosed methods address many of the shortcomings of conventional social networking platforms. For example, the novel computer-implemented methods for matching users to attend events together discussed herein accommodate people's interest in forming various types of relationship, including both platonic and romantic relationships, rather than being limited to one type or the other. Additionally, the novel methods enable users to invite their friends outside of a computer system implementing the method to engage with event group members.

Desirably, the novel computer-implemented methods presented in this document are effective to match individuals into event groups to attend in-person or virtual events together. Helpfully, the novel methods allow people to specify parameters for the event groups to yield event groups comprised of compatible people. For example, the novel methods enable users to specify parameters like the age and gender of people making up an event group. Usefully, the novel methods allow users to specify the number of people an event group will have.

A further advantage of the novel methods disclosed herein is that they enable people to invite friends to potentially join event groups with them. Desirably, the novel methods have the capacity to enable members of an event group to communicate prior to an event to become familiar with each other and/or to coordinate logistics ahead of time.

### Method Embodiment One

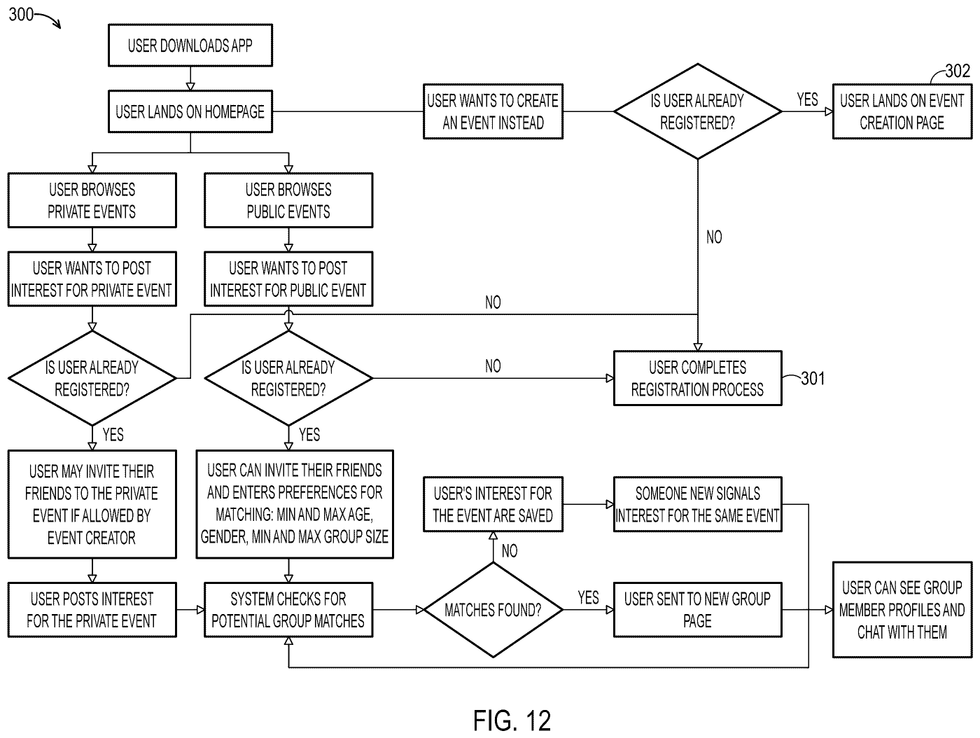

With reference to FIGS. 1-11, a first example of a computer-implemented method for matching users to attend events together, method 200, will now be described. Another embodiment of a computer-implemented method for matching users to attend events together, method 300, is shown in FIGS. 12-16 and discussed further in a separate section below.

Method 200 is a social networking method facilitating users forming groups to attend events together. Method 200 enables people with shared interest in a given event to organize and socialize with each other. As described further below, method 200 is configured to selectively use similarities of traits shared by users as a factor when selecting members for event groups.

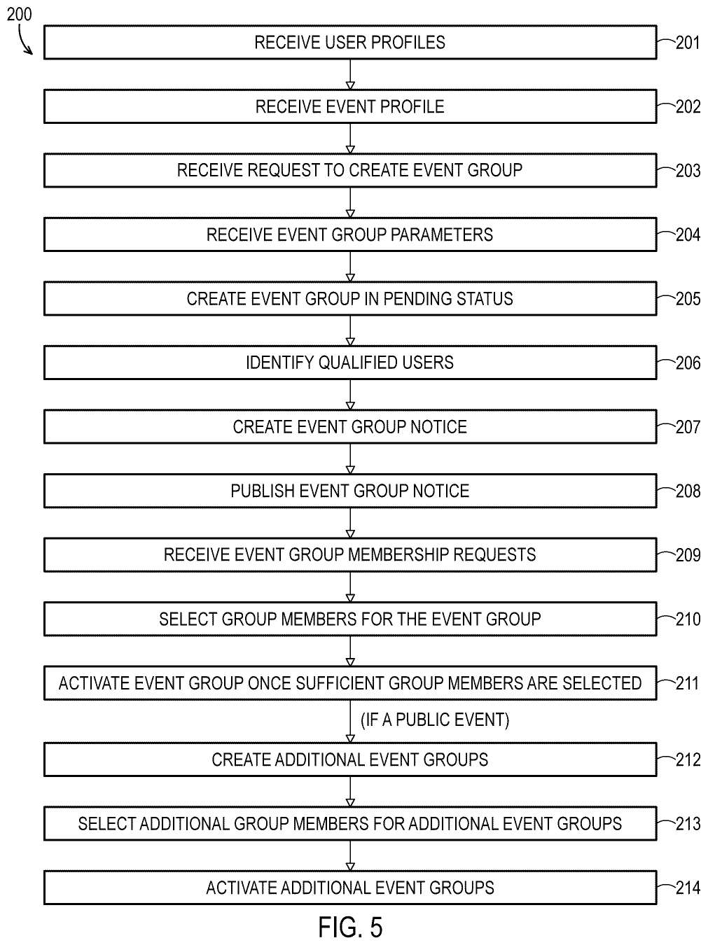

As shown in FIGS. 5-11, method 200 includes multiple steps. Step 201 is receiving a plurality of user profiles. At step 202, an event profile comprising details of an event is received. Step 203 is receiving a request to create an event group. Receiving event group parameters occurs at step 204.

Additional steps include creating an event group at step 205, identifying qualified users from the plurality of user profiles received at step 206, and creating and publishing an event group notice at steps 207 and 208. At step 209, event group membership requests are received. Selecting group members for the event group from the qualified users who submitted group membership requests occurs at step 210. At step 211, the event group is activated once a sufficient number of group members are selected.

For public events, method 200 continues with creating additional event groups at step 212. Step 213 involves selecting additional group members for the additional event groups. At step 214, the additional event groups are activated once a sufficient number of additional group members are selected for each additional event group.

The steps of method 200 are explained further in the sections below. In some examples, the methods according to the present disclosure do not include one or more of the steps shown in FIGS. 5-11 for method 200. In other examples, the methods include additional or alternative steps.

With reference to FIG. 1, method 200 is implemented in a computer system 100. As shown schematically in FIG. 1 in a simplified form, computer system 100 includes a plurality of distributed computing devices in data communication over a data network. Computer system 100 includes a server computer 101, a first user device 102, a second user device 103, and a third user device 104. Server computer 101 is configured to execute method 200 via programmed instructions. User devices 102-104 exchange data with server computer 101 to enable the corresponding users of the devices to participate in method 200.

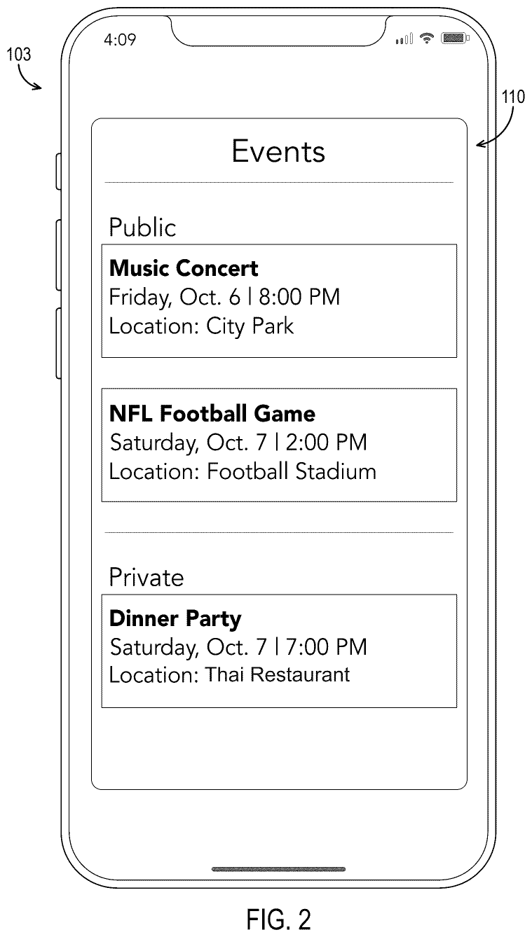

With reference to FIGS. 2-4, a selection of user interfaces presented by server computer 101 on user device 103 is depicted in simplified forms. The user interfaces presented on user device 103 include event and event group information selected specifically for the second user. The user interfaces presented on user devices of other users would include information selected specifically for the other users, such as displaying only event groups the other users were qualified to join if selected.

In FIG. 2, an events listing 110 is depicted as a user interface on user device 103. Event listing 110 enables the second user to browse different event profiles and learn about the events. The event profiles describe events available for users of method 200 to attend, potentially as an event group.

In addition to allowing the second user to learn about different events, events listing 110 enables the second user to request that an event group be formed for a selected event. The second user may specify event group parameters for the event group requested, such as the age and gender of members of the event group.

Further, the second user may create an event profile to be included in event listing 110 for other users to potentially see. Other users will see event profiles if their event preferences align with the event parameters specified for the new event. If the new event created includes an event parameter designating it to be a private event, an event group may be automatically created with event group parameters supplied by the creator of the private event.

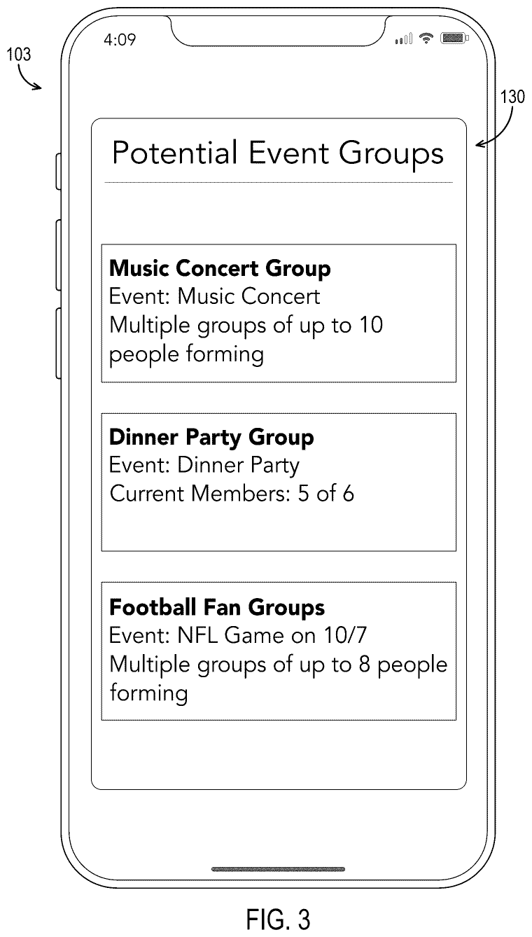

In FIG. 3, an event group listing 130 is depicted as a user interface on user device 103 enabling the second user to browse different event groups associated with events. Event group listing 130 on user device 103 is limited to event groups that the second user is qualified to potentially join. As described further below, a user may express interest in joining an event group and potentially be selected as a group member for the event group.

Unlike events listing 110, which presents event profiles and enables users to initiate forming event groups directed to the events, the events group listing presents potential event groups to joins. As described further below, there could be multiple potential event groups associated with the same event. One event group for a given event may be for users who are aged 20 to 25 while another event group for the same given event may be for users who are aged 23 to 28. If the second user was 24 years old, she would qualify for both event groups and could decide if she would rather attend the event with a group of people aged 20 to 25 or aged 23 to 28 by seeking admission in the corresponding event group.

From event groups listing 130, the second user may select a given event group to learn more about the event group parameters and the event to which the event group pertains. If the second user was interested in joining the event group she was viewing, she could request admission by clicking a button with a label reciting “Match,” “Like,” or “Join” or similar text or an icon of some kind. Additionally or alternatively, the user could request admission by providing some other form of user input, like a swipe or flip gesture. Method 200 includes various steps directed to selecting users for admission to event groups, and those steps are described in more detail below.

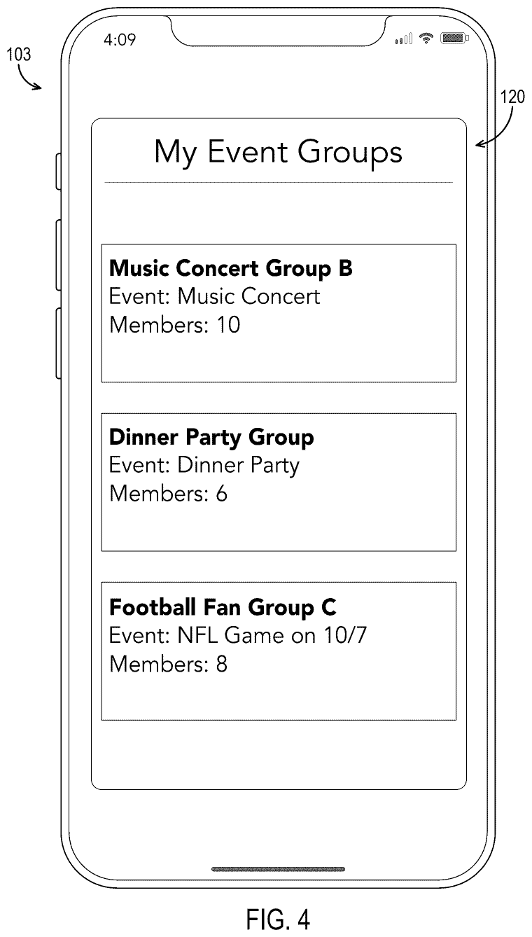

In FIG. 4, a joined event groups listing 120 is depicted as a user interface on user device 103. Joined event groups listing 120 enables the second user to browse event groups she has been selected to join as a group member via method 200.

Server computer 101 may be instructed by method 200 to present a wide variety of additional or alternative user interfaces on the user devices to implement various functions of method 200.

### Receiving a Plurality of User Profiles

Receiving a plurality of user profiles at step 201 functions to build a database of records corresponding to the various users of method 200. As shown in FIG. 1, the user profiles are received by server computer 101 from data sent by various users via user devices 102-104 over a data network.

Each user profile received includes traits of a respective user. The user profiles may also include various administrative particulars, such as the name, contact information, and billing information of the respective user. The user profile may also include the user's preferred geographic region in which to attend events and/or images of the user or other images the user elects to share.

A wide variety of traits may be sought and received at step 201. For example, the traits may include one or more of biographies, lifestyles, and personal preferences of the respective users. The traits may further include the gender, age, sexual orientation, dating interest, and relationship status of the respective users. The traits may be any information relevant to forming event groups in method 200.

The traits received for the user profiles at step 201 serve various purposes in method 200. For example, the traits may be used to determine a similarity score for users who meet qualifications for a given event group as part of selecting group members for an event group at step 210.

As shown in FIG. 5, selecting group members for an event group at step 210 may include determining a similarity score for qualified users at step 220 and selecting qualified users with the highest similarity score to be group members for the event group at step 221. The similarity score determined at step 220 represents the extent to which qualified users for an event group share common traits. Accordingly, the traits included in the user profiles of the qualified users may be the primary basis for the similarity score determined at step 220.

### Receiving an Event Profile

Receiving an event profile at step 202 serves to populate a database of events accessed by users in method 200. Events are activities of various kinds that users of method 200 may wish to attend as part of an event group.

The event profiles received include details of an event, including event parameters. The details of the event may include a description of the event, images relevant to the event, and information about sponsors of the event.

The event parameters specify pertinent details about an event relevant to which users see an event in event listing 120 and relevant to users deciding if they are interested in attending the event. The event parameters, notably, private or public event parameters, also control how event groups are created and activated in method 200. An event with a private event parameter is referred to herein as a private event, and an event with a public event parameter is referred to as a public event.

Event groups are created at step 205 in response to different triggers for public and private events. For example, for public events, event groups are created at step 205 upon receipt of a form requesting the creation of an event group at step 203 for the public event viewed in event listing 120 with event group parameters specified at step 204. For private events, event groups are created at step 205 upon receipt of the private event profile at step 202.

When a private event profile is submitted by a user at step 202, the user is prompted to specify event group parameters at step 204 for an event group automatically associated with the private event at step 203. Attending the private event requires that a user satisfy event group parameters for the private event, request membership in the event group at step 209, and be selected for the event group associated with the private event at step 210.

Further, attending a private event requires that the event group associated with the private event be activated at step 211. As discussed further below, activating an event group at step 211 occurs when a requisite number of users are selected for the event group at step 210. If the event group for the private group is not activated at step 211 because an insufficient number of users are selected for the event group or for another reason, the event group created at step 205 and the private event created at step 202 will be deactivated. In real-world context, a group of users will not be organized to attend the real-world event together via method 200 when the event group created at step 205 fails to activate at step 211.

Another important distinction between public and private events relates to the number of event groups formed for the event. For example, a single event group will be created at step 205 and potentially activated at step 211 for a private event. In contrast, for public events, multiple event groups may be created at steps 205 and 212 for the same public event and potentially activated at steps 211 and 214.

As shown in FIG. 2, event listing 110 displays two public events and a private event. The private event is labeled Dinner Party. The public events are labeled Music Concert and NFL Football Game. Event groups associated with the event profiles depicted in FIG. 2 are depicted in FIGS. 3 and 4.

With reference to FIG. 3, the reader can see that potential event groups listed in event group listing 130 include event groups for the public events labeled Music Concert and NFL Football Game. The event groups for these public events indicate that multiple groups may be formed for the public events. The Music Concert Group will include up to 8 people in each event group while each event group in the Football Fans Group will include up to 10 people.

With reference to FIG. 4, the reader can see that the second user is in Music Concert Group B, indicating that she is in the second event group formed for the Music Concert Group event group. With continued reference to FIG. 4, it can be seen that the second user is in Football Fan Group C, indicating that she is in the third event group formed for the Football Fan Group event group.

Unlike the event groups corresponding to public events, FIGS. 3 and 4 demonstrate that a single event group is associated with private events. For example, as shown in FIG. 3, the event group for the private event labeled Dinner Party in event group listing 130 indicates that the single event group will include up to 6 people with 5 members having already been selected. FIG. 4 reinforces that a single event group is created for the private event labeled Dinner Party by lacking an A, B, C indicator of multiple groups in the event group label.

A wide variety of event parameters are contemplated. For example, the event parameters may include whether the event is public or private, an admission fee for the event, age restrictions on the event (for example, an event at a bar may require one to be at least 21 years old to enter), the location of the event, the duration of the event, and other similar parameters.

A user may specify event preferences in his or her user profile that are compared to the event parameters to filter event profiles the user sees in event listing 120. For example, a user may specify a preference to see events only within 20 miles of his location. An event with a location event parameter more than 20 miles from the user will accordingly not be included in event listing 120 displayed to the user. However, an event with a location event parameter less than 20 miles would appear in the list of event profiles displayed to the user.

Similarly, the user may save a preference in his user profile that he wishes to see only events that are free to attend. An event with an admission fee parameter of no charge to attend would appear in the user's event feed while an event with an admission fee parameter of a $10 cover charge would be excluded from the user's event feed.

### Receiving a Request to Create an Event Group

Receiving a request to create an event group at step 203 initiates the process of establishing an event group for a given event. Event groups are collections of users of method 200 who are interested in attending a given event with other users.

A user may select a given event from event listing 110 shown in FIG. 2 and request to create an event group pursuant to step 203 via the event profile displayed for the event. Requesting to create an event at step 203 may be accomplished by pressing a “create event” or similarly labeled button displayed in the event profile. Pressing the button may display a form for the user to specify details and parameters for the event group pursuant to step 204.

Form fields for the event group may include a name field and a description field among other fields. The name field allows the user to specify a name for the event group. The description field allows the user to provide a description for the event group, such as goals for the event group or text designed to create interest in joining the event group. The parameter fields of the event group form are described below in connection with step 204.

A user submitting the event group form with required and optional event group information causes server computer 101 to receive the request to create an event group at step 203.

### Receiving Event Group Parameters

A user submitting the event group form with parameter information at step 203 also causes server computer 101 to receive event group parameters at step 204. The event group parameters define requirements for people to be eligible to join an event group.

In the present example, the event parameters include age range and gender parameters. For example, a given user may wish to create an event group for a dance club event comprised of women between 20-24 years old. Another user may wish to create an event group for the same dance club event comprised of both men and women between 25 and 30 years old.

A wide range of additional or alternative event group parameters may be specified. For example, event group parameters may involve experience or lack thereof in a given sport or activity, membership in a given group, and/or certification in a given trade or profession.

In some examples, the event group parameters include a group capacity parameter. The group capacity parameter defines a minimum and a maximum number of group members allowed for the event group. In the instance of event groups for public events, the event parameters for minimum and maximum number of group members may apply to multiple event groups formed for the public event at step 212.

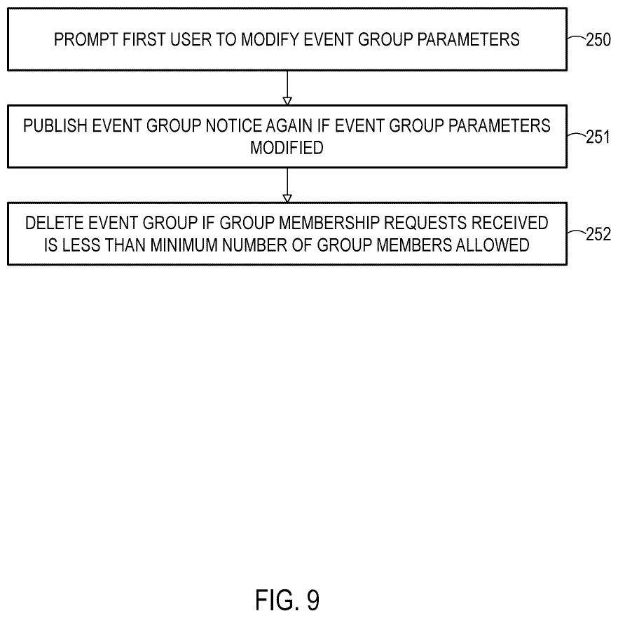

In some examples, as shown in FIG. 9 method 200 includes deleting the event group at step 252 if the number of event group membership requests received is less than the minimum number of group members allowed as defined in the group capacity event group parameter. Prior to deleting the event group at step 252, the user who created the event group and specified the event group parameters may be prompted at step 250 to modify the event group parameters. For example, the user may wish to reduce the minimum group capacity number to better reflect interest in the event group and/or expand the age range or gender parameters to qualify more users for the event group. If the user elects to modify the event group parameters at step 250, a notice of the event group may be published again at step 251 with the new parameters for qualified users to see in event group listing 130.

In some examples, the event group parameters include whether qualified users are allowed to invite friends to join the event group. A qualified user may wish to invite a friend for various reasons, including preferring to already know someone in an event group and/or wanting to introduce a friend to someone in an event group.

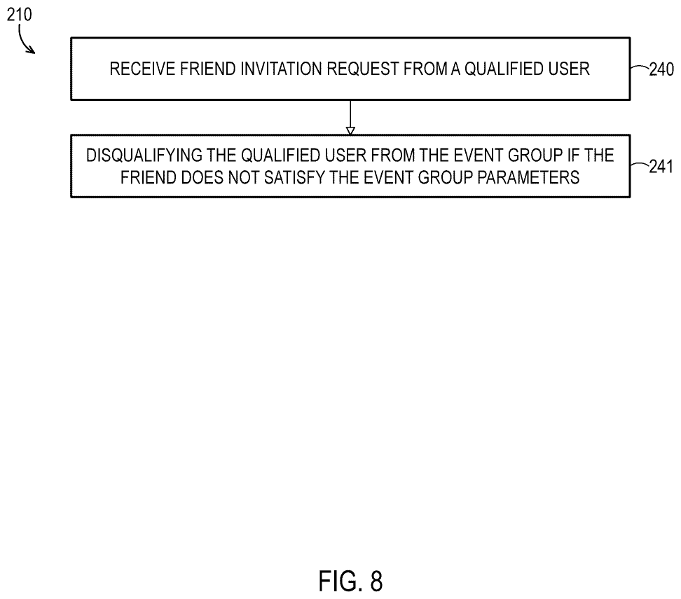

As shown in FIG. 8, when the event group parameters allow it, method 200 includes receiving a request from a qualified user to invite a friend to join the event group at step 240. In some examples, the qualified user's request to invite the friend links the qualified user and the friend for event group selection purposes at step 210. When the qualified user and the friend are linked, selecting group members for the event group at step 210 involves either selecting both the qualified user and the friend for an event group or selecting neither the qualified user or the friend. For example, as shown in FIG. 8, step 241 involves disqualifying the qualified user from an event group if the friend linked to the qualified user does not satisfy the event group parameters.

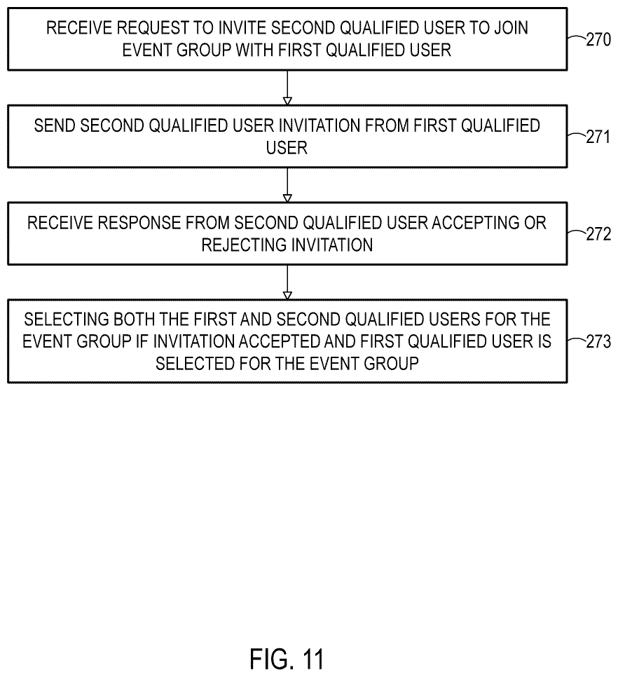

FIG. 11 further depicts method steps associated with a qualified user inviting a friend to join an event group. As shown in FIG. 11, method 200 includes receiving a request from a first qualified user to send a second qualified user a request to join the event group together at step 270. At step 271, server computer 101 sends the second qualified user the invitation from the first qualified user to join the event group together. Method 200 may further include receiving a response from the second qualified user at step 272.

The response received from the second qualified user at step 272 may accept or reject the invitation of the first qualified user to join the event group together. At step 273, both the first qualified user and the second qualified user are selected as group members for the event group if two conditions are met. One, the response from the second qualified user accepts the request of the first qualified user. Two, the first qualified user and the second qualified user have sufficiently high similarity scores compared to other qualified users interested in joining the event group. Expressed another way, the first and second qualified users have more competitive similarity scores than other qualified users and are thus selected for the event group ahead of other qualified users.

The event group form displayed upon pressing a button to create an event group includes event group parameter fields. The event group parameter fields include gender and age range fields. The gender field allows the user to indicate whether members of the event group are required to be male, female, or either. The age range field allows the user to specify age range requirements, such as between 25 and 30 years old, greater than 21 years old, or less than 40 years old. The form may include other event group parameter fields, including a freeform field where a user may type in additional requirements.

### Creating an Event Group

Creating an event group at step 205 occurs in response to different triggers depending on the event parameters for a given event. For public events, an event group is created at step 205 following receipt of a user's request to create an event group at step 203 with event group parameters specified at step 204. For private events, an event group is created at step 205 automatically when the event profile for the private event is created at step 202. As discussed above, participation in private events is limited to users who meet the event group parameters established by the user who created the private event.

Of note, creating an event group at step 205 is not the same thing as activating an event group at step 211. As shown in FIG. 5, the event group created at step 205 is designated as pending. More specifically, the event group created at step 205 is pending activation at step 211. If the event group fails to activate at step 211, the event group is left in pending or inactive status or may be affirmatively deactivated or deleted. An event group that does not activate at step 211 will not materialize into an active event group where group members can communicate via step 261 or attend an event together via method 200.

Creating an event group at step 205 functions to associate a potential event group that may be activated at step 211 with an event profile and event group parameters received at 202 and 204. The potential event group created at step 205 also serves to store event group details received at step 203 to be published to event group listing 130 at step 208. The potential event group created at step 205 further serves as a nucleus for interested, qualified users to request joining at step 209 and to be potentially selected as group members at step 210.

The methods described herein may include a review process whereby event group details and parameters submitted at steps 203 and 204 are evaluated for compliance with standards set by the party managing computer system 100 and/or compliance with local laws and regulations. Proposed event groups with parameters or other details found noncompliant or objectionable may be rejected and the event group will not be created at step 205 absent modification of the event group request and/or parameters received at steps 203 and 204.

### Identifying Qualified Users

Once an event group with associated event parameters is created for an event at step 205, qualified users are identified at step 206. Identifying qualified users at step 206 determines which users will see notice of the event group created at step 205 in event group listing 130. The qualified users identified at step 206 will be eligible to submit requests to join the event group at step 209 and may be selected to join the event group as group members at step 210.

The qualified users are identified at step 206 from the plurality of user profiles received at step 201. The qualified users are users having user profiles that satisfy the event group parameters established at step 204. For example, if an event group has event group parameters including that group members must be male and between the ages of 30 and 35, a 33 year old male user would be a qualified user while an 18 year old male user would not be. Likewise, a 32 year old female user would not be a qualified user of the example event group.

### Create and Publish an Event Group Notice

Creating an event group notice at step 207 provides information about the event group created at step 205 for other users to see and consider joining the event group. The event group notice created at step 207 is published to event group listing 130 at step 208.

Qualified users identified at step 206 are able to view the event group notice and other event group notices in event group listing 130 on their user devices, such as user device 103 depicted in FIG. 3. Users that are not qualified to join the event group because they do not meet one or more of the event group parameters specified for the event group will not see the event group notice in the event group listing loaded onto their device. For each user of computer system 100, server computer 101 filters out event group notices from event group listing 130 that the respective user does not qualify to attend based on the event group parameters and the user's user profile data.

A user clicking an event group notice in event group listing 130 loads an event group notice page with more information about the event group than appears in event group listing 130. The event group notice page may include an extended narrative description of the event group, relevant images, and/or videos. Additionally or alternatively, information about the user who created the event group may be included in the event group notice page.

The event group notice page further includes a user input feature enabling a qualified user to request to become a member of the event group at step 209. The user input feature may be a button or slider a user may selectively click or move, respectively, to generate an event group membership request indicating he or she is interested in joining the event group. The user input feature may be labeled “Join Group” or other similar text. In addition or alternatively to a button or slider, the user input feature may be code that responds to a user swiping or making other gestures on the event group notice page.

### Receiving Event Group Membership Requests

Receiving event group membership requests at step 209 creates a pool of qualified users interested in joining the event group. The event group membership requests are initiated by qualified users from the event group notice page loaded upon a qualified user selecting the event group notice displayed in event group listing 130.

The pool of qualified users interested in joining an event group will often exceed the maximum capacity specified for the event group. Accordingly, as described further below, method 200 includes specific methodologies for selecting group members from the pool of qualified users at step 210.

The user who created the event group may be informed when qualified users submit event group membership requests. In some examples, other users of computer system 100, such as qualified users who already submitted event group membership requests, may also be informed when qualified users submit event group membership requests. Additionally or alternatively, the total number of event group membership requests submitted may be displayed to selected users.

### Selecting Group Members for the Event Group

Selecting group members for an event group at step 210 populates the event group with group members. The group members are selected for the event group at step 210 from the pool of qualified users who submitted event group membership requests at step 209. The manner in which group members are selected is described further below.

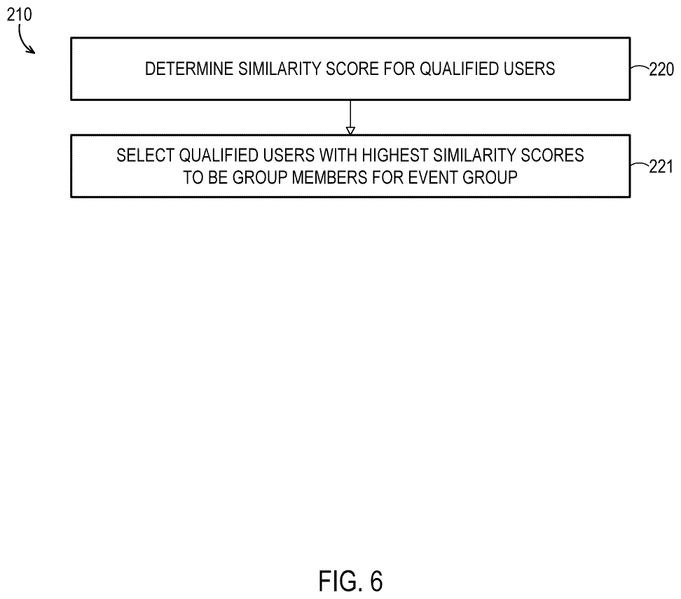

With reference to FIG. 6, selecting group members at step 210 may include determining a similarity score at step 220 and selecting qualified users with the highest similarity score at step 221. The similarity score determined at step 220 represents the extent to which qualified users for an event group share common traits based on their respective user profiles. In the instance of an event group for a private event, the similarity score determined at step 220 represents commonalities between the qualified users and the user who initiated the private event.

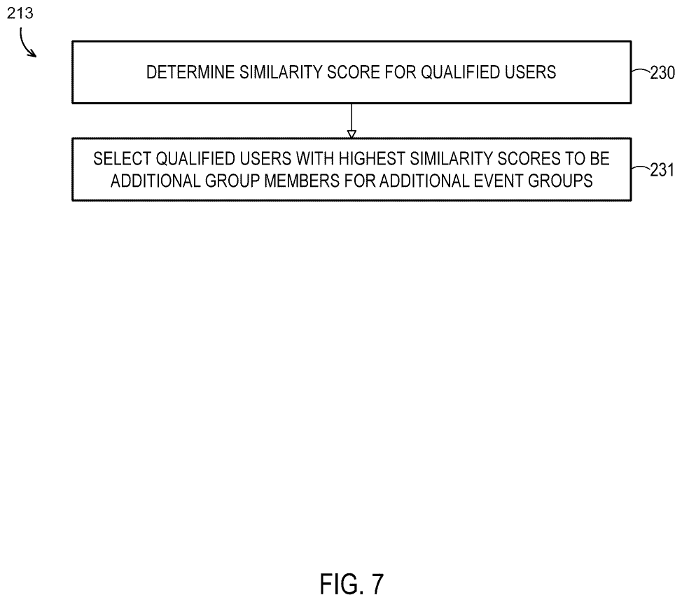

In the instance of an event group for a public event, the similarity score determined at step 220 represents commonalities between the qualified users and the user who initiated the event group for the public event. When additional event groups are automatically created for a public event at step 212, as shown in FIG. 7, a similarity score is determined at step 230 based on trait similarities among qualified users not yet selected for an event group at step 221 or step 231. At steps 221 and 231, the qualified users with the highest similarity scores relative to each other are selected to be group members for event groups being established.

The similarity score may be determined based on one or more of machine learning and textual analysis techniques. The textual analysis may include analyzing the text used to describe the traits included in the user profiles of the respective users. In some examples, the similarity score is determined by utilizing a matrix of personal preference data included in the user profiles.

### Activating Event Group

Activating the event group at step 211 functions to establish the event group among the group members and within computer system 100. Once the event group is activated at step 211, the group members are informed that a sufficient number of users have been selected for the event group and provided with instructions for attending the associated event together.

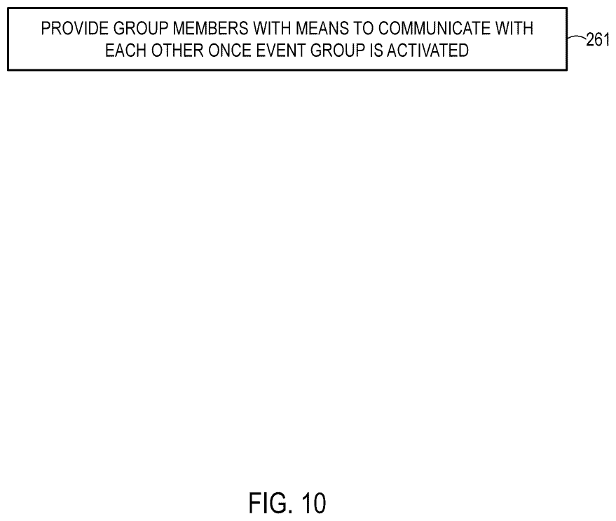

Further, as shown in FIG. 10, server computer 101 provides group members with means to communicate with each other at step 261 once the event group is activated at step 211. The means to communicate may include activating a chat or messaging system among the group members within computer system 100. Additionally or alternatively, the means to communicate may include sharing contact information of each group member with the other group members. The contact information may be anonymized to preserve the users' privacy.

The event group is activated at step 211 when a sufficient number of qualified users are selected to join the event group as group members at step 210 following the qualified users' requests to join the event group at step 209. The number of group members sufficient for the event group is established by the event group parameters received at step 204. In particular, the number of qualified users selected for the event group at step 210 necessary to activate the event group at step 211 is determined by the event group capacity parameter. The event group capacity parameter sets one or more of a minimum or maximum number of qualified users required for the event group.

In some examples, as shown in FIG. 9 method 200 includes deleting the event group at step 252 if the number of qualified users requesting membership in the event group at 209 and/or the number of qualified users selected for the event group at step 210 is less than the minimum number of group members allowed as defined in the group capacity event group parameter. Prior to deleting the event group at step 252, the user who created the event group and specified the event group parameters may be prompted at step 250 to modify the event group parameters to potentially facilitate more qualified users being selected for the event group.

### Additional Event Groups for Public Events

For public events, additional event groups are automatically created at step 212 when more qualified users seek to join an event group than the maximum capacity event group parameter for the event group. Creating additional event groups at step 212 allows most or all of the users interested in attending the public event to be selected for event groups with users having similar traits to attend the public event together.

The number of additional event groups formed at step 212 may be based on the total number of qualified users who submitted group membership requests divided by the maximum number of group members allowed as defined by the group capacity parameter. For example, if the initial event group created at step 205 for a public event has a maximum capacity event group parameter of 10 people and 36 qualified users request to join the event group, three additional event groups will be automatically created at step 212 to accommodate users 11-36 not selected for the initial event group at step 210. The group capacity parameter received at step 204 or set by default by server computer 101 will typically define a minimum and a maximum number of group members allowed for the initial event group and the additional event groups.

At step 213, additional group members are selected for the additional event groups. As shown in FIG. 7, selecting additional group members for the additional event groups at step 213 includes determining a similarity score for the qualified users at step 230. The similarity score is based on the traits included in the user profiles of the qualified users and represents the extent to which the qualified users share common traits. With continued reference to FIG. 7, selecting additional group members at step 213 includes selecting qualified users with the highest similarity scores to be additional group members for the additional event groups at step 231.

At step 214, the additional event groups are activated once a sufficient number of additional group members are selected for each additional event group at step 213.

### Additional Embodiments

With reference to the figures not yet discussed, an additional method embodiment will now be introduced. The additional embodiment includes many similar or identical features to method 200.

### Method Second Embodiment

Turning attention to FIGS. 12-16, a second example of a computer-implemented method for matching users to attend events together, method 300, will now be briefly described. FIGS. 12-16 depicts steps of method 300 more granularly than the steps depicted in FIGS. 5-11 for method 200. Many of the underlying concepts involved with the steps depicted in FIGS. 12-16 have been covered extensively above and will not be redundantly discussed again in this section.

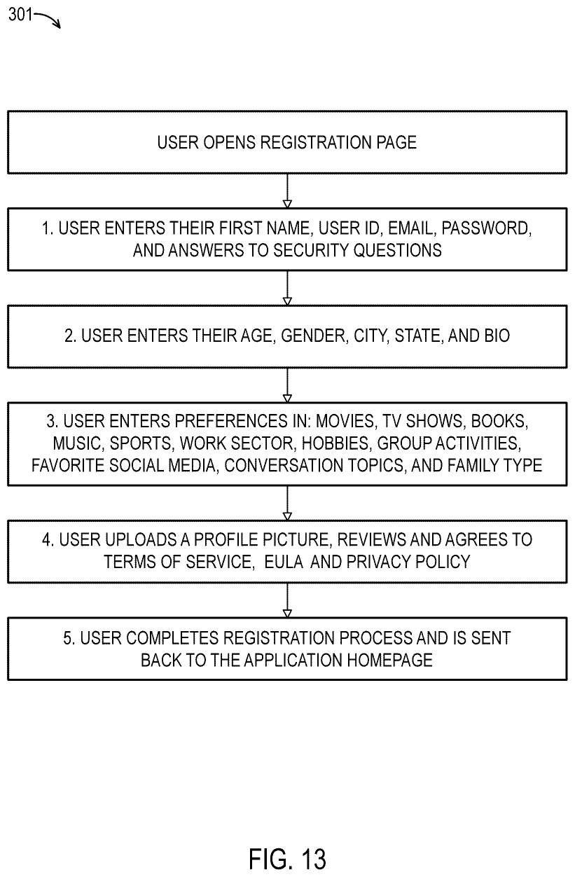

As can be seen in FIG. 12, method 300 includes a plurality of steps involved with selectively matching users to attend events together in event groups. Of note, step 301 in FIG. 12 is a user completing a registration process to become registered with the computer system implementing method 300. Sub-steps involved with the user completing the registration process at step 301 are depicted in FIG. 13.

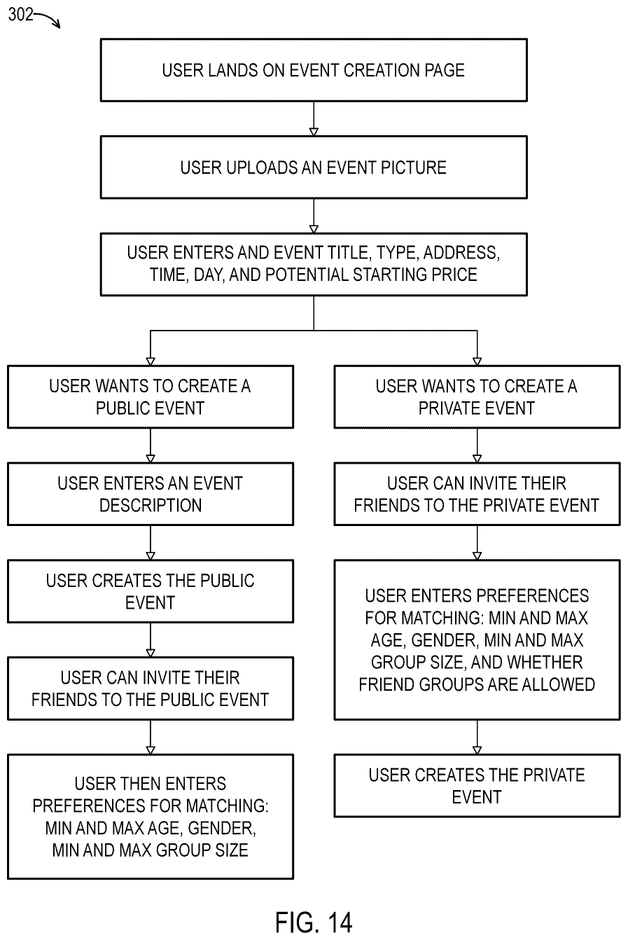

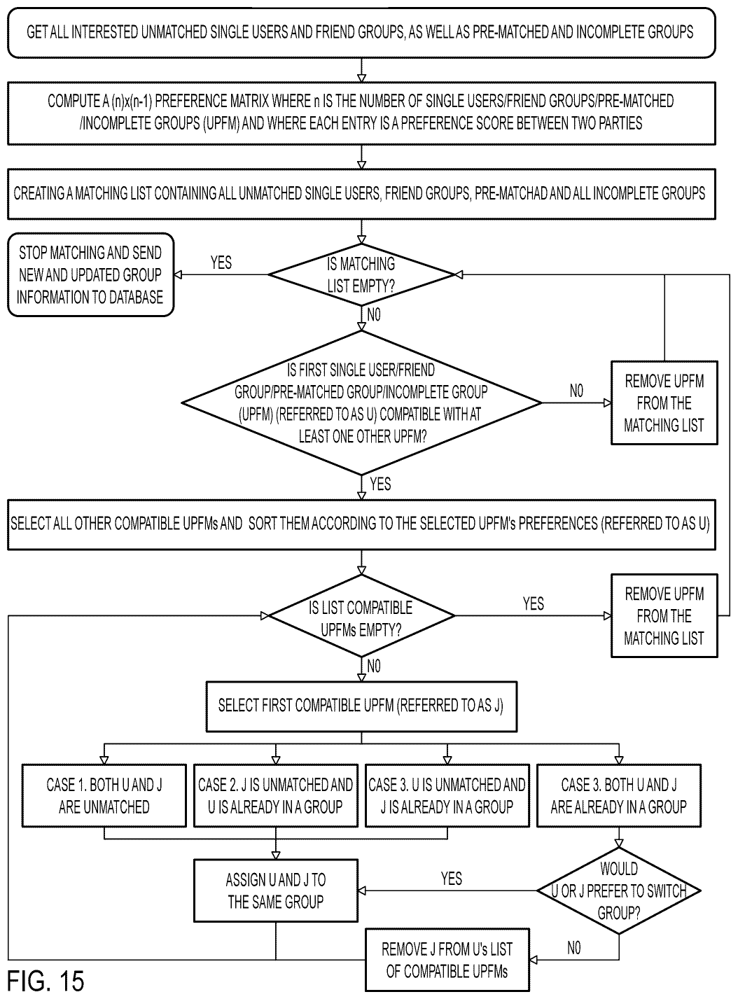

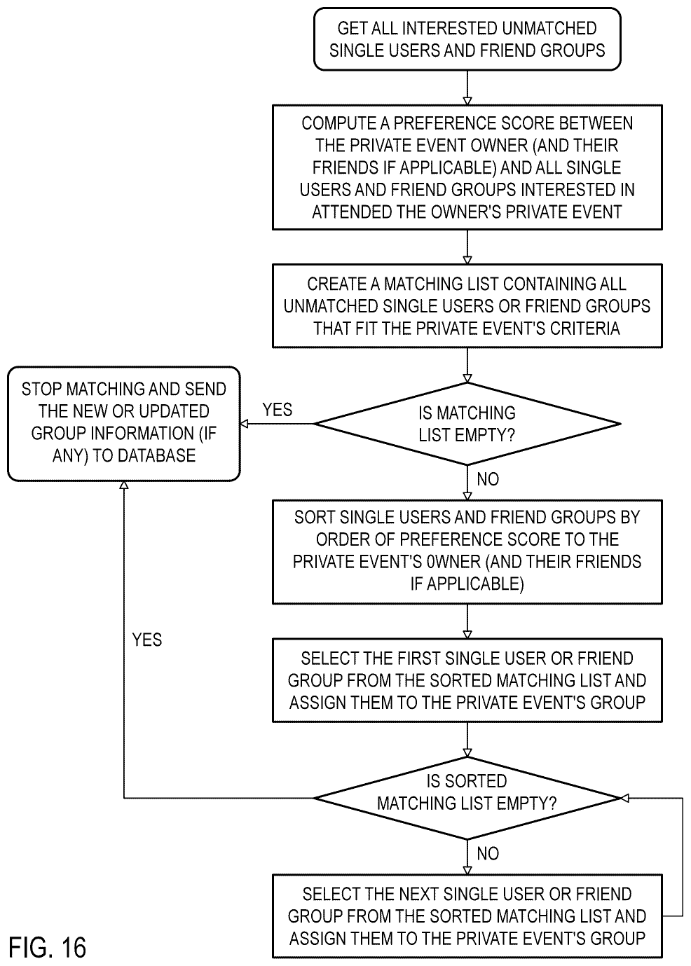

FIG. 12 also depicts an event creation step 302. Sub-steps associated with a user creating an event at step 302 are shown in FIG. 14. FIGS. 15 and 16 granularly depict a plurality of method steps associated with selecting qualified users to join event groups for public and private events.

The reader should understand that the method steps depicted in FIGS. 12-16 represent just one example of a method for matching users to attend events together. A wide variety of alternative steps are contemplated and method examples may include additional or fewer steps than depicted in FIGS. 12-16.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A computer-implemented method for matching users to attend events together, comprising:
receiving a plurality of user profiles, each user profile comprising traits of a respective user;
receiving an event profile comprising details of an event;
receiving a request to create an event group for the event from a first user;
receiving event group parameters specified by the first user, the event group parameters including gender and age requirements for participation in the event group;
creating an event group with the event group parameters;
identifying qualified users from the plurality of user profiles received, the qualified users having user profiles satisfying the event group parameters;
creating an event group notice seeking members to join the event group to attend the event together;
publishing the event group notice in an event group list accessible to the qualified users;
receiving event group membership requests from the qualified users interested in joining the event group; and
selecting group members for the event group from the qualified users who submitted group membership requests.

2. The method of claim 1, wherein selecting group members for the event group includes:
determining a similarity score for each qualified user relative to the first user based on the traits included in the user profiles of the qualified users and the first user, the similarity score representing the extent to which the qualified users and the first user share common traits;
selecting qualified users with the highest similarity scores to be group members for the event group.

3. The method of claim 2, wherein the traits include one or more of biographies, lifestyles, and personal preferences of the respective users.

4. The method of claim 3, wherein the similarity score is determined based on machine learning and textual analysis of the traits in the user profiles of the respective users.

5. The method of claim 2, wherein:
the traits include personal preference data of the respective users; and
the similarity score is determined by utilizing a matrix of the personal preference data.

6. The method of claim 1, wherein the event profile includes whether the event is a public event or a private event.

7. The method of claim 6, wherein, when the event is a public event:
the event group defines an initial event group; and
the method further comprises creating additional event groups.

8. The method of claim 7, further comprising selecting additional group members for each of the additional event groups from the qualified users who submitted group membership requests.

9. The method of claim 8, wherein selecting additional group members for each of the additional event groups includes:
determining a similarity score based on the traits included in the user profiles of the qualified users, the similarity score representing the extent to which the qualified users share common traits; and
selecting qualified users with the highest similarity scores to be additional group members for the additional event groups.

10. The method of claim 9, wherein:
the event group parameters include a group capacity parameter defining a minimum and a maximum number of group members allowed for the initial event group and the additional event groups; and
the number of additional event groups formed is based on the total number of qualified users who submitted group membership requests divided by the maximum number of group members allowed as defined by the group capacity parameter.

11. The method of claim 1, wherein the event group parameters include whether qualified users are allowed to invite friends to join the event group.

12. The method of claim 10, wherein:
the method further comprises receiving a request from a qualified user to invite a friend of the qualified user to join the event group when the event group parameters provide that qualified users are allowed to invite friends to join the event group; and
the request to invite the friend links the qualified user and the friend such that selecting group members for the event group either selects both the qualified user and the friend or selects neither the qualified user and the friend.

13. The method of claim 11, wherein selecting group members for the event group includes disqualifying the qualified user from the event group if the friend does not satisfy the event group parameters.

14. The method of claim 1, wherein the event group parameters include a group capacity parameter defining a minimum and a maximum number of group members allowed for the event group.

15. The method of claim 14, further comprising deleting the event group if the number of event group membership requests received is less than the minimum number of group members allowed as defined in the group capacity parameter.

16. The method of claim 14, further comprising prompting the first user to modify the event group parameters if the number of event group membership requests received is less than the minimum number of group members allowed as defined in the group capacity parameter.

17. The method of claim 1, further comprising selectively providing group members with means to communicate with each other.

18. The method of claim 17, wherein group members are selectively provided with means to communicate with each only after the event group is activated.

19. The method of claim 1, further comprising:
receiving a request from a first qualified user to send a second qualified user a request to join the event group together; and
sending the second qualified user the invitation from the first qualified user to join the event group together.

20. The method of claim 19, further comprising:
receiving a response from the second qualified user accepting or rejecting the invitation of the first qualified user to join the event group together; and
selecting both the first qualified user and the second qualified user as group members for the event group if the response from the second qualified user accepts the request of the first qualified user to join the event group together and similarity scores for the first qualified user and the second qualified user based on traits included in their user profiles are sufficiently high compared to other qualified users interested in joining the event group.
